(19) United States
(12) Patent Application Publication
(10) Pub. No.: US 2011/0115722 A1
(43) Pub. Date: May 19, 2011

(54) SYSTEM AND METHOD OF ENTERING SYMBOLS IN A TOUCH INPUT DEVICE

(75) Inventor: Tsz K. Mok, Hong Kong (CN)

(73) Assignee: SONY ERICSSON MOBILE COMMUNICATIONS AB, Lund (SE)

(21) Appl. No.: 12/674,829

(22) PCT Filed: Nov. 12, 2009
(86) PCT No.: PCT/IB09/07437

§ 371 Date: Feb. 23, 2010

(30) Foreign Application Priority Data
Nov. 13, 2008 (CN) 2008101814374

(51) Int. Cl. G06F 3/041

(52) U.S. Cl. 345/173

(57) ABSTRACT

A portable communication device (12) is equipped with a touch input device (16) that displays a plurality of key input regions, wherein at least one of the key input regions includes a plurality of symbols. A key press may be detected in one of the key input regions, which causes symbols associated with the selected key to be displayed in one or more adjacent key input regions. The user may slide an object (e.g., a finger, stylus, etc.) across from one key input region to another key input region to select a particular symbol. Generally, the symbol is selected by detecting a key release in the key region associate the selected symbol.

### RELATED APPLICATION DATA

This application claims priority from Chinese Patent Application No. 200810181437.4 filed on Nov. 13, 2008, which is incorporated herein by reference.

### TECHNICAL FIELD OF THE INVENTION

The present invention relates generally to a system and method of entering symbols in a touch input device and more specifically to a system and method for disambiguation of a plurality of alphanumeric characters and/or symbols in a touch input device.

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continues to expand. Portable communication devices are appealing to users because of their capability to serve as powerful communication, data service and entertainment tools.

Portable communication devices typically include a keypad having alphanumeric keys. Conventional alphanumeric keypads include a plurality of keys. A majority of the keys include a number and three or four letters printed thereon. For example, the number nine usually has “WXYZ” printed thereon. In many of these keypads a user must first press a text menu key and subsequently press a specific key several times for entering a text symbol. For example, a user must press the key with the number nine thereon four times in order to enter the text symbol “Z”. Such a process for entering text symbols is time consuming and error prone. Furthermore, this process becomes even more time consuming as well as cumbersome and inefficient when a user is attempting to write a text message with a multiplicity of alphanumeric key entries. Another disadvantage with conventional keypads is that the symbols are generally fixed and a user is generally unable to select graphical elements for use in a message or other text entry.

### SUMMARY

In view of the foregoing, a need exists for a system and method of a touch input device that has improved functionality. The present invention provides a touch input device that displays a plurality of key input regions, wherein at least one of the key input regions includes a plurality of symbols. A key press may be detected in one of the key input regions, which causes symbols associated with the selected key to be displayed in one or more adjacent key input regions. The user may slide an object (e.g., a finger, stylus, etc.) across from one key input region to another key input region to select a particular symbol. Generally, the symbol is selected by detecting a key release in the key region associate the selected symbol.

One aspect of the invention relates to a portable communication device including: a housing; a touch input device secured to the housing, the touch input device operatively coupled to a display and control circuitry, wherein the control circuitry is configured to: display a keypad having a plurality of key input regions on the display, wherein at least one of the key input regions includes a plurality of symbols; detect a key press in one of the key input regions, wherein the key input region where the key press was detected corresponds to a selected key input region; displaying one or more of the plurality symbols associated with the selected key input region in one or more adjacent key input regions from the selected key input region, wherein each of the plurality of symbols are positioned in a separate key input region to allow direct selection of one of the plurality of symbols; detecting a slide from the selected key input region to another key input region, wherein one of the plurality of symbols are displayed; and detecting a key release in one of the adjacent key input regions corresponding to a selected symbol.

Another aspect of the invention relates to the control circuitry outputting the selected symbol to the display.

Another aspect of the invention relates to the control circuitry detecting the key release outside of one of the key input regions then no symbol is selected.

Another aspect of the invention relates to displaying one or more of the plurality symbols associated with the selected key input region in the one or more adjacent key input regions and non-adjacent additional key input regions are disabled.

Another aspect of the invention relates to upon detecting the key release, an audible indication is output from the portable communication device.

Another aspect of the invention relates to upon detecting the key release, a tactile feedback is output from the portable communication device.

Another aspect of the invention relates to at least one of the key input regions including one or more graphic representations for use in a text entry application.

Another aspect of the invention relates to the one or more symbols and/or graphic representations being distributed over the one more key input regions based upon an associated user's preference.

Another aspect of the invention relates to the touch input device and the display are integrally formed in a touchscreen display.

One aspect of the invention relates to a method of entering symbols in an electronic device having a touch input device, the method including: displaying a plurality of key input regions on a display, wherein at least one of the key input regions includes a plurality of symbols; detecting a key press from an object in one of the key input regions of a touch input device, wherein the key input region where the key press was detected corresponds to a selected key input region and the selected key input region includes a plurality of symbols associated with the selected key input region; displaying one or more of the plurality of symbols associated with the selected key input region in one or more adjacent key input regions from the selected key input region, wherein each of the plurality of symbols are positioned in a separate key input region to allow direct selection of one of the plurality of symbols; detecting a slide of the object from the selected key input region to another key input region, wherein one of the plurality of symbols are displayed; and detecting a key release in one of the adjacent key input regions corresponding to a selected symbol, wherein the key release is detected by detecting an absence of contact of the object on the touch input device.

Another aspect of the invention relates to outputting the selected symbol to the display.

Another aspect of the invention relates to including detecting if the key release is outside of one of the adjacent key input regions then no symbol is selected.

Another aspect of the invention relates to when displaying one or more of the plurality symbols associated with the selected key input region in the one or more adjacent key input regions and non-adjacent key input regions are disabled.

Another aspect of the invention relates to upon detecting the key release, an audible indication is output from a speaker coupled to a control circuit that controls the display.

Another aspect of the invention relates to upon detecting the key release, a tactile feedback is output from a tactile feedback device that is coupled to a control circuit that controls the display.

Another aspect of the invention relates to at least one symbol and/or graphic are distributed over the one more key regions is based upon an associated user's preference.

One aspect of the present invention relates to a portable communication device including: a touchscreen display operatively coupled to touchscreen control circuitry, wherein the touchscreen control circuitry is configured to: display a plurality of key input regions on the touchscreen display, wherein at least one of the key input regions includes a plurality of symbols; detecting a key press in one of the key input regions, wherein the key input region where the key press was detected corresponds to a selected key input region; displaying one or more of the plurality symbols associated with the selected key input region in one or more adjacent key input regions from the selected key input region; detecting a slide from the selected key input region to another key input region; and detecting a key release in one of the adjacent key input regions corresponding to a selected symbol.

Another aspect of the invention relates to the touchscreen control circuitry outputting the selected symbol to the touchscreen display.

Another aspect of the invention relates to the at least one of the key input regions including one or more symbols and/or graphics that are distributed over the plurality of key input regions when a corresponding key input region is selected.

Another aspect of the invention relates to the at least one symbol and/or graphic are distributed over the one more key regions based upon an associated user's preference

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of an exemplary keypad according to aspects of the present invention.

FIG. 2 is a diagrammatic illustration of an exemplary portable communication device in accordance with aspects of the present invention.

FIG. 3 is a diagrammatic illustration of another exemplary portable communication device in accordance with aspects of the present invention.

FIG. 4 is a diagrammatic illustration of the exemplary portable communication device of FIG. 2 displaying the keypad of FIG. 1.

FIG. 5 is a schematic diagram of an exemplary portable communication device in accordance with aspects of the present invention.

FIG. 6 is a flow chart of an exemplary method for entering symbols in accordance with aspects of the present invention.

FIGS. 7-15 illustrate various implementations of the method of FIG. 6.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

The present disclosure describes a portable communication device equipped with a touch input device in the form of a touch screen display and/or a touch pad. The touch input device is operatively coupled to control circuitry and a display. The control circuitry is configured to perform the following steps: display a keypad have a plurality of key input regions on a display, wherein at least one of the key input regions includes a plurality of symbols; detect a key press in one of the key input regions, wherein the key input region where the key press was detected corresponds to a selected key input region; display one or more of the plurality symbols associated with the selected key input region in one or more adjacent key input regions from the selected key input region, wherein each of the plurality of symbols are positioned in a separate key input region to allow direct selection of one of the plurality of symbols; detect a slide from the selected key input region to another key input region; and detect a key release in one of the adjacent key input regions corresponding to a selected symbol. The selected symbol may be output to the display and/or used by one or more application programs in a desired manner.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment equipped with a touch input device.

Referring to FIG. 1, a keypad 10 is illustrated on a touch input device. The keypad 10 may be presented on the device in a fixed, static surface image or on a liquid crystal display or other display or screen having a digitizer extending across the screen (e.g., a touch screen display). When the touch input device is a liquid crystal display or other display or screen having a digitizer extending across the screen, the display may dynamically change the keypad based upon received user's input and directly receive user input from the liquid crystal display. When the touch input device is a touchpad, the display may dynamically change based upon a user controlling a mouse displayed on the displayed from the touchpad.

The keypad may include text characters, graphics and/or combination of text and graphics that are displayed directly on the touch input device (e.g., when the touch input device is the form of a touchscreen display) or displayed on a display adjacent the touch input device (e.g., when the touch input device is a keypad (e.g., a digitizer).

As shown in FIG. 1, each key of the keypad 10 is illustrated having a rectangular (or square) boundary. The boundary associated with a particular key is referred to herein as a key input region (also commonly referred to as a button). The number of key input regions may be fixed, set by a user and/or set by an application. In one embodiment, there are at least twelve buttons for text input. As is described in greater detail below, software and/or or a controller in the portable communication device maintains a one-to-one mapping of the boundaries for the key input regions.

Using a pointing device (e.g., a finger, a stylus, etc.) a number of physical actions can be performed on each key input region. Such actions include, for example, a key press (e.g., downward force in the key input region on the touch input device), a slide-action from one key input region to another key input region (e.g., pressure maintained by the pointing device after the key press is detected and the pointing device moves from one key input region to another while maintaining pressure on the key input device), and a release action (e.g., lifting of the pointing device from a key input region). These actions will be described in detail below.

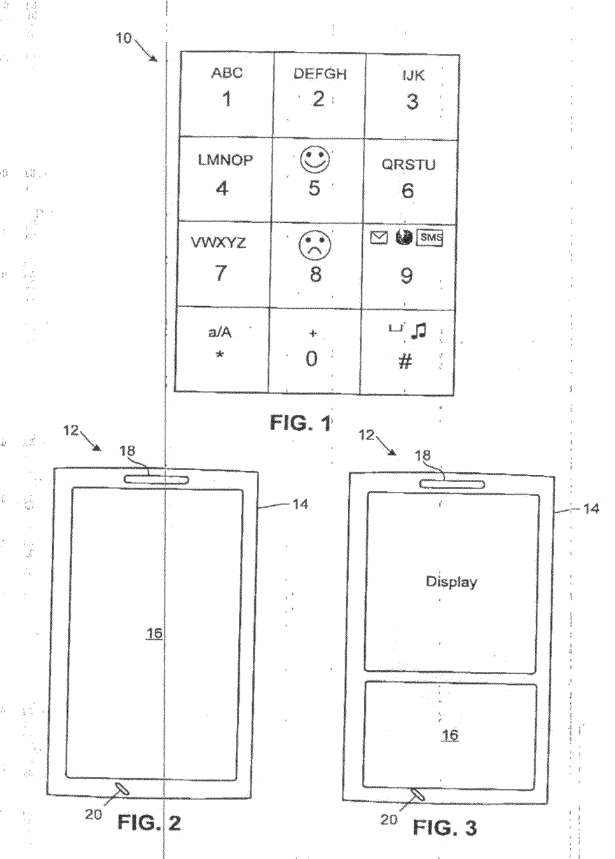

Referring to FIGS. 2 and 3, a portable communication device 12 is shown in accordance with aspects of the present invention. In the exemplary embodiments described herein, the portable communication device is a mobile phone. Of course, it will be appreciated that the present invention is applicable to other portable communication devices. The portable communication device 12 is shown as having a “block” type of housing 14, but it will be appreciated that other housing types, such as clamshell or slide-type housings may be utilized without departing from the scope of the present invention.

Referring to FIG. 2, the portable communication device 12 includes a touch input device 16. The touch input device 16 may be a touchscreen display that detects presence and location of a touch within the display area. The touch input device 14 enables a user to interact with what is displayed directly on the screen.

Another embodiment of the present invention is illustrated in FIG. 3. In FIG. 3, the portable communication device 12 includes a touch input device 16 and a display 15. The touch input device 16 may be a touch pad (e.g., a digitizer) that detects presence and location of a touch within the touch pad area. The touch pad may control a cursor on the display 15. The touch pad generally allows a user to indirectly interact with what is displayed on the display 15 (e.g., by controlling a mouse on the display). In such cases, the display 15 will generally be a conventional non-touch display. However, a touchscreen display may also be used in accordance with the present invention.

Referring collectively to FIGS. 2 and 3, the portable communication device 12 may also include a speaker 18 and a microphone 20 to allow a user to carry out conventional telephone functions.

For the sake of brevity, the following description will discuss aspects of the present invention in terms of the touch input device 14 being a touchscreen display. One of ordinary skill in the art will readily appreciate that this description is also applicable other touch input devices (e.g., a touch pad).

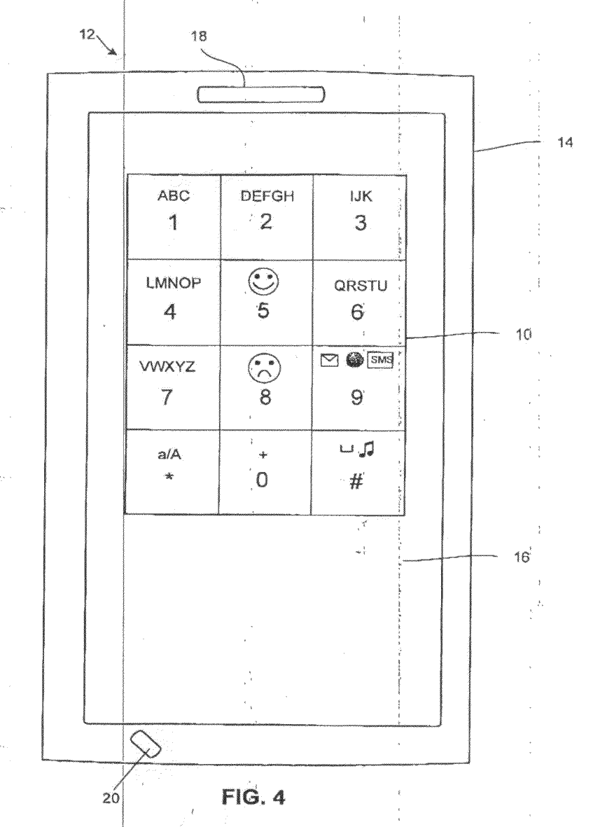

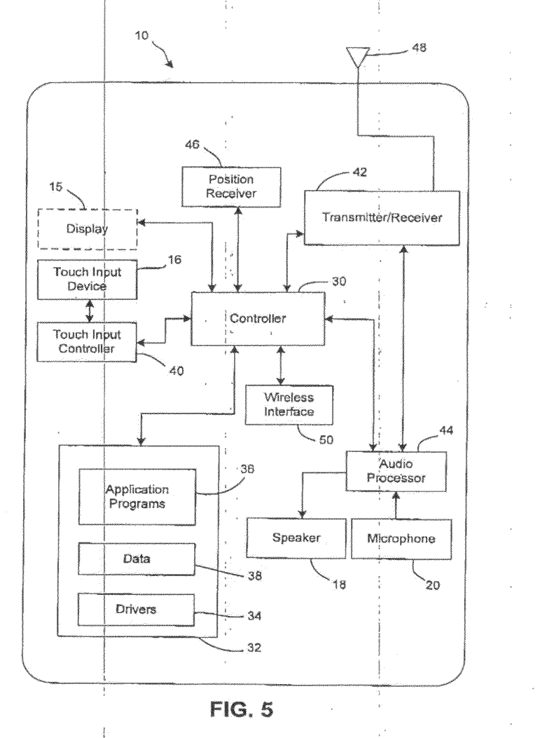

Referring to FIG. 4, the mobile telephone 12 is illustrated having a keypad 10 displayed directly on the touch input device 16 (e.g., touchscreen). The keypad 10 may be configured in any desired manner. For example, the keypad 10 may include a plurality of keys that may be used to select alphanumeric keys, functional keys, keys used to represent emotions and/or feelings (e.g., the keys may have one or more graphical representations of various emotions and/or feelings displayed thereon, etc.).

As shown in FIG. 4, the keypad 10 includes the numbers 0-9 distributed over 10 distinct key input regions. Such a distribution allows direct selection of a particular number upon a user selecting a key input region corresponding to the selected key. For example, if the user desires to select the number “1”, the user simply touches the key input region corresponding to the number “1”. The keypad 10 also includes conventional telephone keypad symbols “*” (e.g., asterisk or star key) and “#” (e.g., hash key). The “*” and “#” keys also allows for direct selection of the key by simply selecting the corresponding key input region.

Many of the keys of the keypad 10 are also associated with additional symbols that may be used when the user is in a text entry mode. For example key number “1” is associated with symbols “A”, “B”, “C”. Key number “2” is associated with symbols “D”, “E”, “F”, “G”, and “H”. Key number “3” is associated with symbols “I”, “J”, “K”. Key number “4” is associated with symbols “L”, “M”, “N”, “O”, and “P”. Key number “5” is associated with “happy” icons (e.g., smiley face icons, star icons, etc.). Key number “6” is associated with symbols “Q”, “R”, “S”, “T”, and “U”. Key number “7” is associated with symbols “V”, “W”, “X”, “Y”, “Z”. Key number “8” is associated with “sad” icons (e.g., sad face icons, broken heart, tears, etc.). Key number “9” is associated with software applications (e.g., electronic mail application, Internet browsing applications, texting applications, etc.) that may be launched upon selection. The asterisk or star key (e.g., *) may be associated with changing the symbols from uppercase to lower case and vice versa and/or perform other text related functions. Key “0” may be associated with mathematical operations, such as addition, subtraction, multiplication, division, equals, etc. The hash key (e.g., “#”) may be associated with text entry functions, e.g., space bar and/or inserting multimedia in a message, for example.

One of ordinary skill in the art will readily appreciate that the above description is illustrative in nature and one or more of the keys may be associated with different symbols and/or functions and/or icons. In addition, a user may configure the keypad 10 to include user defined symbols and/or frequently used texting symbols and/or words. The user may also customize the distribution of icons and/or characters in any desired manner.

The keypad 10 facilitates controlling operation of the portable communication device 12 by allowing for entry of alphanumeric information, such as telephone numbers, phone lists, contact information, notes and the like. The touch input device 16 also displays information to a user, such as recorded digital media, e.g., recorded photos and videos, operating state, time, phone numbers, contact information and various navigational menus, which enable the user to utilize the various features of the portable communication device 12. One of ordinary skill in the art will appreciate that the portable communication device 12 further includes suitable circuitry and software for performing various functionality. The circuitry and software of the mobile phone is coupled with input devices, such as the touch input device 16 and the microphone 20, as well as to the output devices, including the speaker 18 optionally separate display 15 (if present).

FIG. 5 represents a functional block diagram of a portable communication device 12, e.g., a mobile phone. The portable communication device 12 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, and application program data 38. The I/O device drivers include software routines that are accessed through the controller 30 (or by an operating system (not shown) stored in memory 32) by the application programs 36 to communicate with devices such as a touch input device 16, optionally display 15, as well as other input/output ports. As is described more fully below, the touch input device is operatively coupled to and controlled by a touch input controller 40 (e.g., a suitable microcontroller or microprocessor) and configured to provide both key press (also referred to as touch key) functionality and sliding functionality. Although the touch input controller 40 is shown separately, the touch input controller operation may be performed partially or fully by controller 30. As is described more fully below, the touch input controller 40 cooperates with the touch input device 16 to send “events” (e.g., press events, slide events and release events) to the controller based on detected user manipulation of the touch input device 16.

The application programs stored in memory 32 comprise programs that implement various features of the portable communication device 10, such as voice calls, e-mail, Internet access, multimedia messaging, text messaging, contact manager and the like.

With continued reference to FIG. 5, the controller 30 interfaces with the aforementioned touch input device(s) 16 (and any other user interface device(s)), a transmitter/receiver 42 (often referred to as a transceiver), audio processing circuitry, such as an audio processor 44, and a position determination element or position receiver 46, such as a global positioning system (GPS) receiver. The portable communication device 10 may include a media recorder (e.g., a still camera, a video camera, an audio recorder or the like) that captures digital pictures, audio and/or video. Image, audio and/or video files corresponding to the pictures, songs and/or video may be stored in memory 32.

An antenna 48 is coupled to the transmitter/receiver 42 such that the transmitter/receiver 42 transmits and receives signals via antenna 48, as is conventional. The portable communication device includes an audio processor 44 for processing the audio signals transmitted by and received from the transmitter/receiver. Coupled to the audio processor 44 are a speaker 18 and microphone 20, which enable a user to listen and speak via the portable communication device. Audio data may be passed to the audio processor 44 for playback to the user. The audio data may include, for example, audio data from an audio file stored in the memory 32 and retrieved by the controller 30 or audio data associated with a generated or received media-enhanced text message. The audio processor 44 may include any appropriate buffers, decoders, amplifiers and the like.

The portable communication device 12 also may include one or more local wireless interfaces (indicated generally as wireless interface 50), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 12 to the adapter, another mobile radio terminal, a computer, or any other electronic device. Also, wireless interface 50 may be representative of an interface suitable for communication within a cellular network or other wireless wide-area network (WWAN).

Referring back to FIG. 4, an exemplary touch input device 16 in the form of a keypad 10 displayed on touchscreen is illustrated. The keypad 10 is configured to provide key press and sliding functionality for entry of alphanumeric text characters and/or graphical elements in the portable communication device 12. The touch input device 16 may be implemented using any suitable touch pad technology that is capable of detecting user manipulation of or contact with a portion of the touch input device.

Using a pointing device (e.g., a finger, stylus, etc.) several physical actions can be performed on each key input region (e.g., button). These actions are a select action, a slide action and a release action. To perform an action, a user taps a selected key input region with the pointing device. The pointing device contacts the touch panel within the boundary of a selected button and the pointing device maintains contact in the key region. A slide action comprises maintaining contact with the touch input device from the select action and moving the pointing device from the selected key input region to a desired key input region while maintaining pressure on the key input device 16. The pointing device is lifted once it has been placed on the desired key input region for selection of the character and/or graphic that corresponds to the detected key input region.

The key input device 16 is connected to the touch input controller 40 and provides x and y coordinates to the touch input controller 40 for identifying the location of the pointing device on the key input device. The touch input controller 40 is coupled to controller 30, as described above. The controller 30 may be a general purpose processor or a microprocessor or a dedicate control device, such as an application specific integrated circuit. The controller 30 is coupled to memory 32 and optionally a display 15 when the touch input device is not a touchscreen display, for example.

As shown in FIG. 4, the touch input device 16 is configured to have a plurality of key input regions (also referred to as keys, key press areas or key detect areas), with one or more key input region including a plurality of symbols that may be disambiguated for text entry. Each key input region generally includes a defined boundary formed by x-y coordinates. Such regions are mapped in memory 32. The configuration of the keys may be customized based on the housing 14 of the portable communication device 12, the type of touch input device 16, the application being used and/or any other design considerations.

It will be appreciated that the touch input device is operatively coupled to the touch input controller 40 (as well as other appropriate programs and the device controller 30). The touch input device (together with its associated control circuitry and/or control programs) is configured to generate key press, slide events and key release events in response to user touch or manipulation of the touch input device. The existing key press, slide and key release events may be mapped to the memory 32 to provide the functional response to user manipulation of the touch input device, as described herein.

A person having ordinary skill in the art of computer programming and/or circuit design, and specifically in applications programming for mobile phones, will be able to program a mobile phone to operate and carry out the functions described herein with respect to the user interaction provided by the touch input device (and any interfacing between the touch input device 16 and its associated touch input controller 40 and other application programs and/or control circuitry) in view of the provided description.

Accordingly, details as to the specific programming code have been left out for the sake of brevity. Also, while the key select, slide and key release functionality may be carried out by any suitable touch input device coupled to a suitable touch input controller touch input controller, such function also could be carried out via dedicated hardware, firmware, software or combinations thereof without departing from the scope of the present invention.

While for purposes of simplicity of explanation, the flow charts or functional diagrams in the following figures include a series of steps or functional blocks that represent one or more aspects of the relevant operation of the portable communication device 12. It is to be understood and appreciated that aspects of the invention described herein are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

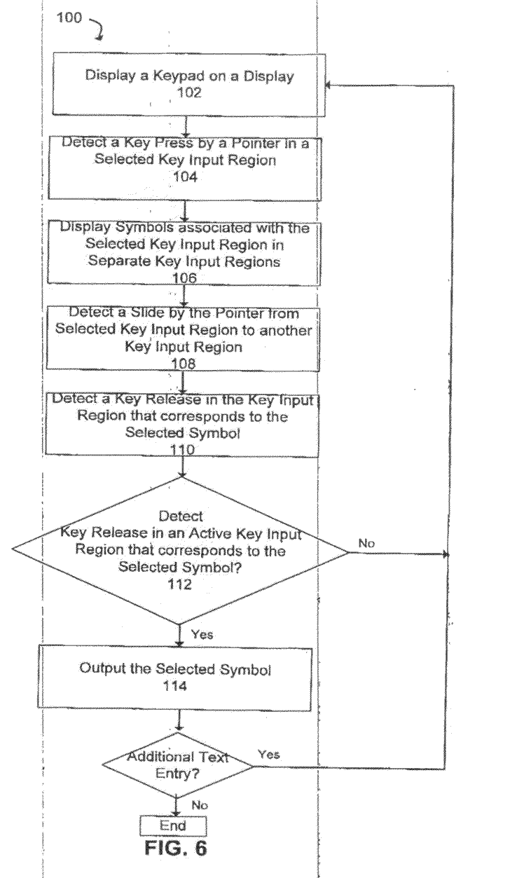

The methodologies illustrated in the following figures, which are shown implemented on or through a portable communication device, relate to an exemplary method 100 of entering symbols in a touch input device. Referring to FIG. 6, the method 100 starts at block 102 wherein a keypad having a plurality of regions is displayed on the touch input device or display 15 if the touch input device is not a touchscreen display. At least one of key input regions includes a plurality of symbols that can be disambiguated for text entry.

At block 104, the touch input device detects a key press in one of the key input regions, wherein the key input region where the key press was detected corresponds to a selected key input region. The x-y coordinates of the selected region are used to obtain information associated with the selected key input region. Such information may include, for example, the location of the key input region, identification of any symbols associated with the selected key input region, location of adjacent key input regions, etc.

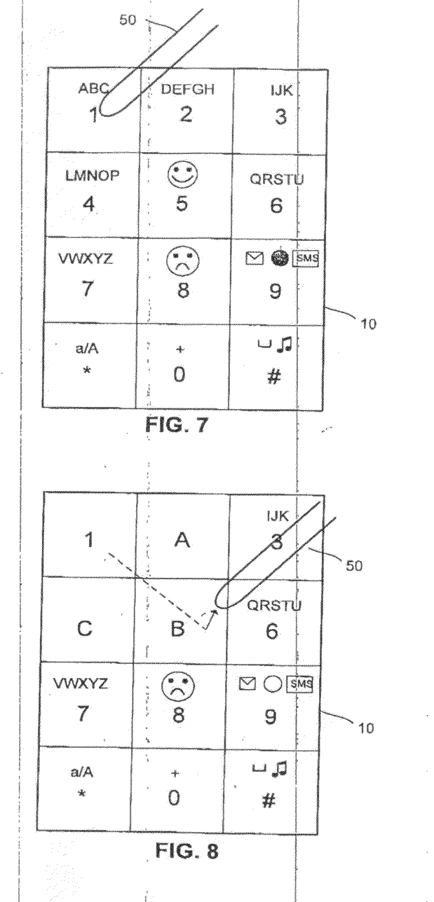

At block 106, the touchpad 10 displays one or more of the plurality symbols associated with the selected key input region in one or more separate key input regions. In one embodiment, the one or more of the plurality of symbols associated with the selected key input region are displayed in key input regions adjacent the selected key input region. In such case, it may be desirable to disable non-adjacent key input regions. In one embodiment, only the key input regions that are associated with the plurality of symbols are active. Other key input regions may be removed from the display and/or made in active. A common way to identify to a user that a key is inactive is to change the color of the key by making the key less conspicuous, as shown in FIG. 8.

At block 108, the touch input device detects a slide from the selected key input region to another key input region. The x-y coordinates of the new key input region may be used by the touch input controller 40 for a variety of purposes. For example, highlighting the newly active key input region, providing commands and/or text entry characters associated with the region, etc. The slide generally requires pressure to be applied to the touch input device from the selection of the original key input region through the slide movement to another key input region.

At block 110, if the key release is detected in an active key input region by the touch input device, the symbol that corresponds to the key input region is the selected symbol. If the key release is detected in an inactive area, control returns to block 102, wherein the keypad is displayed and the method continues as described. Upon detecting the key release, an audible indication and/or tactile feedback may be output from the portable communication device in order to signify to the user the symbol has been selected and/or that the display is about to change.

At block 112, the selected symbol may be output to the touch input device, in the case where the touch input device is a touchscreen display. Alternatively, when the touch input device is a touchpad, the selected symbol may be output to the display 15. Program flow then returns to block 102 or block 114 if no other text is to be entered.

FIGS. 7-15 illustrate various exemplary use cases. For each of the following examples, it will be assumed that the user is presented initially with a keypad 10 as illustrated in FIG. 4. It will also be assumed that after the user selects a particular symbol, the keypad 10 will return to the configuration illustrated in FIG. 4. Although a pointing device 50 in form of an object is illustrated in FIG. 7, one of ordinary skill in the art will readily appreciate that any pointing device 50 (e.g., a finger, stylus, etc.) may also be used in accordance with aspects of the present invention.

Referring to FIG. 7, a user is presented with a keypad 10 on the touch input device (e.g., a touchscreen) or on a display if a touchpad is used. If the user would like to enter text into an application program (e.g., a messaging application, Internet browsing, contact information, etc.), the user may contact the touch input device 16 with a pointing device 50. Referring to FIG. 7, if the user contacts the input key region associated with the number “1”. The touch input controller 40 receives the x-y coordinates of the selected region. The portable communication device outputs corresponding symbols associated with the selected key input region (e.g., number “1”) and displays the symbols in adjacent key input regions. For example, referring to FIG. 7, the symbols associated with key input region for the number “1”, namely “A”, “B”, “C” are displayed on the touch input device 16. While maintaining contact on the touch input device, the user may move the pointing device from the selected key input region to the desired symbol. For example, if the user desires to select symbol “B”, the user slides the pointing device from the selected key input region to the region associated with the desired symbol (e.g., “B”). Once the pointing device is within the key input region associated with the desired symbol, the user may release the key input region by removing contact between the pointing device and the touch input device. The symbol mapped to the region wherein the point device was last detected is output to the portable communication for use as desired, assuming this region is an active region.

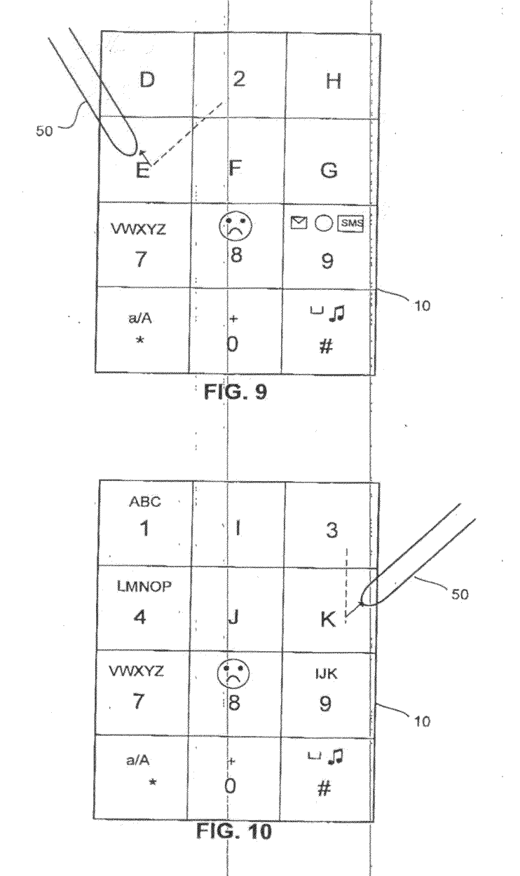

Referring to FIG. 9, if the user selects the key input region associated with the number “2” from the initial keypad shown in FIG. 4, the symbols corresponding to the number “2”, namely “D”, “E”, “F”, “G” and “H” may be displayed on the touch input device as shown in FIG. 9. Other keys may not be displayed and/or indicated as disabled (or inactive), as shown in FIG. 9. While maintaining contact on the touch input device, the user may move the pointing device from the selected key input region to the desired symbol. For example, if the user desires to select symbol “E”, the user slides the pointing device from the selected key input region to the region associated with the desired symbol (e.g., “E”). Once the pointing device is within the key input region associated with the desired symbol, the user may release the key input region by removing contact between the pointing device and the touch input device. The symbol mapped to the region wherein the point device was last detected is output to the portable communication for use as desired.

Referring to FIG. 10, if the user selects the key input region associated with the number “3” from the initial keypad shown in FIG. 4, the symbols corresponding to the number “3”, namely “I”, “J”, “K” are displayed on the touch input device as shown in FIG. 10. Other keys may not be displayed and/or indicated as disabled (or inactive), as shown in FIG. 10. While maintaining contact on the touch input device, the user may move the pointing device from the selected key input region to the desired symbol. For example, if the user desires to select symbol “K”, the user slides the pointing device from the selected key input region to the region associated with the desired symbol (e.g., “K”). Once the pointing device is within the key input region associated with the desired symbol, the user may release the key input region by removing contact between the pointing device and the touch input device. The symbol mapped to the region wherein the point device was last detected is output to the portable communication for use as desired.

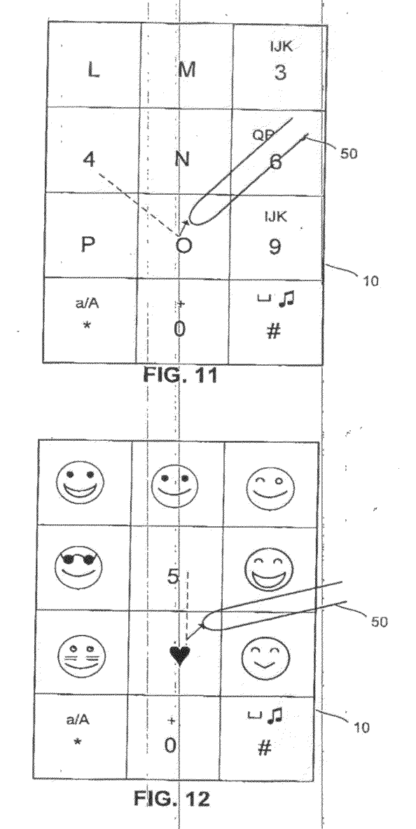

Referring to FIG. 11, if the user selects the key input region associated with the number “4” from the initial keypad shown in FIG. 4, the symbols corresponding to the number “4”, namely “L”, “M”, “N”, “O”, “P” are displayed on the touch input device as shown in FIG. 11. Other keys may not be displayed and/or indicated as disabled (or inactive), as shown in FIG. 11. While maintaining contact on the touch input device, the user may move the pointing device from the selected key input region to the desired symbol. For example, if the user desires to select symbol “O”, the user slides the pointing device from the selected key input region to the region associated with the desired symbol (e.g., “O”). Once the pointing device is within the key input region associated with the desired symbol, the user may release the key input region by removing contact between the pointing device and the touch input device. The symbol mapped to the region wherein the point device was last detected is output to the portable communication for use as desired.

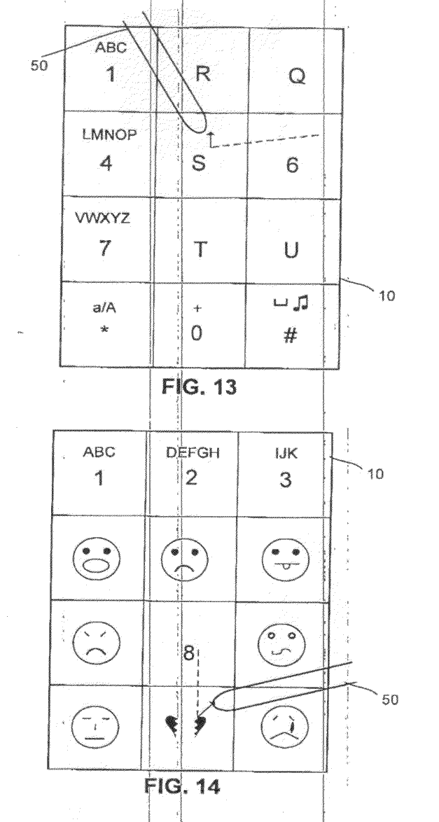

Referring to FIG. 12, if the user selects the key input region associated with the number “5” from the initial keypad shown in FIG. 4, the symbols corresponding to the number “5”, namely “Happy” face icons and/or other graphical characters associated with positive feelings and/or emotions are displayed. Such graphical representations allow a user to easily include such graphics in a messaging applications based on the above described method. As shown in FIG. 12, various icons associated with positive feelings and/or emotions are displayed. The user may customize the symbols, for example, by creating new graphic representations, downloading additional graphic representations, etc.

Other key input regions, for example, those not conveying positive feelings and/or emotions may not be displayed and/or indicated as disabled (or inactive), as shown in FIG. 12. While maintaining contact on the touch input device, the user may move the pointing device from the selected key input region to the desired symbol. For example, if the user desires to select symbol “♡”, the user slides the pointing device from the selected key input region (e.g., the region associate with number “5”) to the region associated with the desired symbol (e.g., “♡”). Once the pointing device is within the key input region associated with the desired symbol, the user may release the key input region by removing contact between the pointing device and the touch input device. The symbol mapped to the region wherein the point device was last detected is output to the portable communication for use as desired.

Referring to FIG. 13, if the user selects the key input region associated with the number “6” from the initial keypad shown in FIG. 4, the symbols corresponding to the number “6”, namely “Q”, “R”, “S”, “T”, “U” are displayed on the touch input device as shown in FIG. 13. Other key input regions may not be displayed and/or indicated as disabled (or inactive), as shown in FIG. 13. While maintaining contact on the touch input device, the user may move the pointing device from the selected key input region to the desired symbol. For example, if the user desires to select symbol “S”, the user slides the pointing device from the selected key input region to the region associated with the desired symbol (e.g., “S”). Once the pointing device is within the key input region associated with the desired symbol, the user may release the key input region by removing contact between the pointing device and the touch input device. The symbol mapped to the region wherein the point device was last detected is output to the portable communication for use as desired.

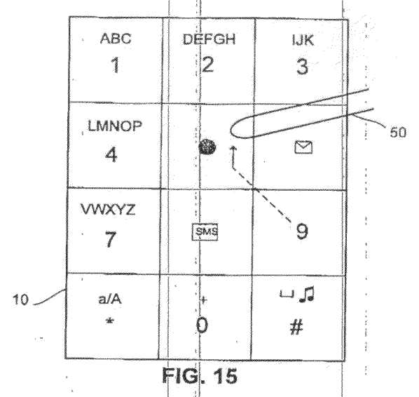

Referring to FIG. 14, if the user selects the key input region associated with the number “8” from the initial keypad shown in FIG. 4, the symbols corresponding to the number “8”, namely “Unhappy” face icons and/or other graphical characters associated with negative feelings and/or emotions are displayed. Such graphical representations allow a user to easily include such graphics in a messaging applications based on the above described method. As shown in FIG. 14, various icons associated with negative feelings and/or emotions are displayed. The user may customize the symbols, for example, by creating new graphic representations, downloading additional graphic representations, etc. Other key input regions, for example, those not conveying negative feelings and/or emotions may not be displayed and/or indicated as disabled (or inactive), as shown in FIG. 14. While maintaining contact on the touch input device, the user may slide the pointing device from the selected key input region to the desired symbol. For example, if the user desires to select the “broken heart” symbol, the user slides the pointing device from the selected key input region (e.g., the region associate with number “5”) to the region associated with the desired symbol (e.g., “broken heart”). Once the pointing device is within the key input region associated with the desired symbol, the user may release the key input region by removing contact between the pointing device and the touch input device. The symbol mapped to the region wherein the point device was last detected is output to the portable communication for use as desired.

Referring to FIG. 15, if the user selects the key input region associated with the number “9” from the initial keypad shown in FIG. 4, the symbols corresponding to the number “9”, namely software applications, such as an electronic mail application, short message system (SMS) application, Internet browsing application, etc. Such graphical representations allow a user to easily launch a software application directly from the user's keypad 10. As shown in FIG. 15, various icons associated with the software applications are displayed in various key input regions. The user may customize the applications available on the touch input device. Other key input regions, for example, those not associated with launching a computer application may not be displayed and/or indicated as disabled, as shown in FIG. 14. While maintaining contact on the touch input device, the user may slide the pointing device from the selected key input region to the desired symbol. For example, if the user desires to select the “Internet” symbol, the user slides the pointing device from the selected key input region (e.g., the region associated with number “9”) to the region associated with the desired symbol corresponding to the desired application (e.g., “Internet”). Once the pointing device is within the key input region associated with the desired symbol, the user may release the key input region by removing contact between the pointing device and the touch input device. The software application mapped to the region wherein the point device was last detected is then launched and the initial keypad 10 may be displayed.

Other exemplary functions and/or text entry capabilities may also be included in the keypad 10. For example, if the user selects the key input region associated with the asterisk or start key “*” from the initial keypad shown in FIG. 4, one more text editing functions may be displayed. Such text editing functions may include, for example, changing font style, color, size, change font from lowercase to uppercase and vice versa, etc. The function may be displayed in separate key input regions, as discussed above.

In another example, if the user selects the key input region associated with the symbol “0” from the initial keypad shown in FIG. 4, one more mathematical functions may be displayed. Such mathematical functions may include, for example, addition, subtraction, multiplication, division, equals, etc. Each of the functions may be displayed in separate key input regions, as discussed above.

In another example, if the user selects the key input region associated with the hash key “#” from the initial keypad shown in FIG. 4, one more miscellaneous functions and/or text entry symbols may be applied and/or input. For example, miscellaneous functions and/or characters that are particularly common and/or useful for a user may be displayed. Such functions and/or characters may include attaching an enclosure for an E-mail communication, adding music to a SMS message, inserting a space between words, etc. Each of the function and/or characters may be displayed in separate key input regions and selected, as discussed above.

One of ordinary skill in the art will readily appreciate that the press, slide and release method of text entry and/or selecting functions may be customized based on the size of the portable communication device, the type of touch input device, the desired functionality of the portable communication device, the type of text applicable to the communication type (e.g., SMS, E-mail, etc.), etc.

As stated above, the above description was directed to a touch input device in the form of a touchscreen display. The present invention is also applicable to the touch input device being a touchpad. When a touchpad is used, the display 15 will change as described above respect to FIGS. 7-15. User manipulation will occur by the user moving the pointing device on the touch pad to control a cursor on the display 15. For example, referring back to FIG. 8, if the portable communication includes a touch pad, the user will maneuver a cursor on the display through user actions detected at the touchpad. When the cursor is in a key region associated with the symbol to be selected, the user will press on the touch input device to select the key input region. Symbols associated with the selected key region will then be displayed in one or more key input regions of the keypad displayed on the display 15. The symbols may be positioned in a separate key input region to allow direct selection of one of the plurality of symbols. In addition, the symbols may be positioned in key input regions adjacent the selected key input region. The touchpad may then detect a slide from the selected key input region to another key input region, wherein one of the plurality of symbols are displayed. The cursor will generally follow the user action detected by the touchpad and move in a similar manner on the display. The touchpad may then detect a key release in one of the key input regions corresponding to a selected symbol. A key release may be detected by the touchpad detecting the absence of pressure generated from the pointing device. The selected symbol may be output as described above.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing;
a touch input device secured to the housing, the touch input device operatively coupled to a display and control circuitry, wherein the control circuitry is configured to:
display a keypad having a plurality of key input regions on the display, wherein at least one of the key input regions includes a plurality of symbols;
detect a key press in one of the key input regions, wherein the key input region where the key press was detected corresponds to a selected key input region;
displaying one or more of the plurality symbols associated with the selected key input region in one or more adjacent key input regions from the selected key input region, wherein each of the plurality of symbols are positioned in a separate key input region to allow direct selection of one of the plurality of symbols;
detecting a slide from the selected key input region to another key input region, wherein one of the plurality of symbols are displayed; and
detecting a key release in one of the adjacent key input regions corresponding to a selected symbol.

2. The portable communication device of claim 1 further including the control circuitry outputting the selected symbol to the display.

3. The portable communication device of claim 1, further including if the control circuitry detects the key release outside of one of the key input regions then no symbol is selected.

4. The portable communication device of claim 1, wherein when displaying one or more of the plurality symbols associated with the selected key input region in the one or more adjacent key input regions additional non-adjacent key input regions are disabled.

5. The portable communication device of claim 1, wherein upon detecting the key release, an audible indication is output from the portable communication device.

6. The portable communication device of claim 1, wherein upon detecting the key release, a tactile feedback is output from the portable communication device.

7. The portable communication device of claim 1, wherein at least one of the key input regions include one or more graphic representations for use in a text entry application.

8. The portable communication device of claim 7, wherein the one or more symbols and/or graphic representations are distributed over the one more key input regions based upon an associated user's preference.

9. The portable communication device of claim 1, wherein the touch input device and the display are integrally formed in a touchscreen display.

10. A method of entering symbols in an electronic device (12) having a touch input device, the method comprising:
displaying a plurality of key input regions on a display, wherein at least one of the key input regions includes a plurality of symbols;
detecting a key press from an object in one of the key input regions of a touch input device, wherein the key input region where the key press was detected corresponds to a selected key input region and the selected key input region includes a plurality of symbols associated with the selected key input region;
displaying one or more of the plurality of symbols associated with the selected key input region in one or more adjacent key input regions from the selected key input region, wherein each of the plurality of symbols are positioned in a separate key input region to allow direct selection of one of the plurality of symbols; and
detecting a slide of the object from the selected key input region to another key input region, wherein one of the plurality of symbols are displayed; and
detecting a key release in one of the adjacent key input regions corresponding to a selected symbol, wherein the key release is detected by detecting an absence of contact of the object on the touch input device.

11. The method of claim 10 further including outputting the selected symbol to the display.

12. The method of claim 10, further including detecting if the key release is outside of one of the adjacent key input regions then no symbol is selected.

13. The method of claim 10, wherein when displaying one or more of the plurality symbols associated with the selected key input region in the one or more adjacent key input regions non-adjacent key input regions are disabled.

14. The method of claim 10, wherein upon detecting the key release, an audible indication is output from a speaker coupled to a control circuit that controls the display.

15. The method of claim 10, wherein upon detecting the key release, a tactile feedback is output from a tactile feedback device that is coupled to a control circuit that controls the display.

16. The method of claim 10, wherein the at least one symbol and/or graphic are distributed over the one more key regions based upon an associated user's preference.

17. A portable communication device comprising:
a touchscreen display operatively coupled to touchscreen control circuitry (40), wherein the touchscreen control circuitry is configured to:
display a plurality of key input regions on the touchscreen display, wherein at least one of the key input regions includes a plurality of symbols;
detecting a key press in one of the key input regions, wherein the key input region where the key press was detected corresponds to a selected key input region;
displaying one or more of the plurality symbols associated with the selected key input region in one or more adjacent key input regions from the selected key input region;
detecting a slide from the selected key input region to another key input region; and
detecting a key release in one of the adjacent key input regions corresponding to a selected symbol.

18. The device of claim 17 further including the touchscreen control circuitry outputting the selected symbol to the touchscreen display.

19. The device of claim 10, wherein the at least one of the key input regions include one or more symbols and/or graphics that are distributed over the plurality of key input regions when a corresponding key input region is selected.

20. The device of claim 10, wherein the at least one symbol and/or graphic are distributed over the one more key regions based upon an associated user's preference.
